(19) United States
(12) Patent Application Publication
(10) Pub. No.: US 2018/0236839 A1
(43) Pub. Date: Aug. 23, 2018

(54) DYNAMIC LOAD DISTRIBUTION SYSTEM FOR ADD-ON-AXLE TRAILERS

(71) Applicant: Superior Synchronized Systems, LLC, Wallace, MI (US)

(72) Inventors: Michael J. Rasner, Wallace, MI (US); Keith Hanson, Stephenson, MI (US)

(73) Assignee: Superior Synchronized Systems, LLC, Wallace, MI (US)

(21) Appl. No.: 15/901,271

(22) Filed: Feb. 21, 2018

Related U.S. Application Data
(60) Provisional application No. 62/462,044, filed on Feb. 22, 2017.

(51) Int. Cl. B60G 17/015; B62D 53/06; B60G 17/019

(52) U.S. Cl. CPC B60G 17/0152; B62D 53/06; B60G 17/019; B60G 2400/61; B60G 2800/24; B60G 2600/04; B60G 2202/413; B60G 2202/416; B60G 2300/042

(57) ABSTRACT

An add-on trailer is provided with a computer control system for automatically or semi-automatically monitoring and controlling the load equalizing function and preferably other functions of the add-on trailer. Display and control software is loaded into a portable computer such as a tablet or personal digital assistant (PDA), with wireless connection to the computer control system in the add-on trailer, such that the computer control system can be operated remotely.

This application claims priority to U.S. Provisional Application Ser. No. 62/462,044 filed Feb. 22, 2017, and entitled DYNAMIC LOAD DISTRIBUTION SYSTEM FOR ADD-ON-AXLE TRAILERS.

### FIELD OF THE INVENTION

The present invention is in the field of load distributing add-on-axle trailers, for adding at least one axle to a load carrying trailer, and distributing the trailer load between the trailer axle or axles and the add-on-axle. The term “load carrying trailer” or “trailer” is intended to encompass any type of load carrying trailer, including without limitation semi-trailers, lowboy trailers, flatbed trailers, freight trailers, tanker trailers, step deck trailers, removable gooseneck trailers, dry vans, extendable double drop trailers, refrigerated trailers, Conestoga trailers, heavy haul trailers, etc. The term “add-on-axle” refers to the axle of the “add-on-axle trailer.” The combination of a truck, load carrying trailer and add-on-axle trailer is referred to herein as a “rig.”

### BACKGROUND OF THE INVENTION

By regulation, heavy duty load carrying trailers typically have a per-axle load limit on what they carry, usually 25,000 pounds per axle. Add-on-axle trailers have double acting hydraulic lifter cylinders which extend to lift the trailer load off the load carrying trailer axles, thereby distributing the weight of the load between the trailer axles and the axle of the add-on-axle trailer. Thus, a two axle semi-trailer can carry a 75,000-pound load by attaching the add-on-axle trailer, and using the lifter cylinders to distribute the load such that each of the three axles is carrying 25,000 pounds. FIG. 1 illustrates the way extension of the lifter cylinders 31 of add-on-axle trailer 20 lift the load carrying trailer 10 to reduce its per axle load. FIG. 2 illustrates the way the retraction of the lifter cylinders 31 increases the load on the load carrier 10, and as desired, can lift the add-on axle trailer off the ground.

A mechanical gauge on the add-on trailer measures the pressure in the ride height air bag, located between the axle and the add-on trailer frame. This provides the user with a point of reference, but the air pressure reading is not used to set the load to be transferred to the add-on-axle trailer. That determination is made based on a hydraulic pressure gauge on the hydraulic system of the add-on-axle trailer. The relationship between hydraulic pressure in the add-on-axle trailer hydraulic system and the load on the add-on trailer axle has been empirically determined and is presented on a chart associated with the add-on axle trailer. To transfer the required load to the add-on axle, the operator starts the hydraulic pump, which is typically gasoline powered, and opens a valve to pump fluid to the cylinders to extend them. When the mechanical gauge shows a hydraulic pressure corresponding to the desired load on the add-on axle, as indicated by the chart, the operator closes the valve and turns off the hydraulic pump. The entire process is manually accomplished, and is performed only before travel begins.

Both the trailer axles and the add-on-axle have associated pressurized airbags between the wheel axles and their respective frames, whereby the ride heights of the trailer and the add-on axle trailer are maintained during travel of the rig. Height adjustment is automatically maintained via ride height valves associated with each axle on the trailer and add-on trailer, which are operated by mechanical linkage between the frame and axle. If the trailer frame or add-on trailer frame is too low, the linkage opens the ride height valve to allow air to flow into the air bags to raise the frame height. On the other hand, if the frame is riding too high, the linkage opens the ride height valve to release air from the airbags and lower the frame. When the trailer air system is first coupled to the truck air compressor via a quick disconnect coupling, air flows into the trailer air bags to initially establish the intended ride height. The ride height valves continue to operate the flow of air to and from the air bags during the travel of the rig, thereby tending to maintain the trailer and add-on trailer at the proper level though-out the travel of the rig.

### SUMMARY OF THE INVENTION

In the present invention, the add-on trailer is provided with a computer control system for automatically or semi-automatically monitoring and controlling the load equalizing function and preferably other functions of the add-on trailer. Preferably, display and control software is loaded into a portable computer such as a tablet or personal digital assistant (PDA), with wireless connection to the computer control system in the add-on trailer, such that the computer control system can be operated remotely.

Prior artisans have failed to appreciate that while ride height of the trailer and add-on trailer tend to remain constant throughout the travel of the rig, the load distribution on the axles does not. The present invention facilitates a dynamic load distribution system for automatically initially setting at the time of loading the load trailer, and then maintaining throughout its trip, a generally uniform load on each of the load carrying trailer axles and the-add-on axle. The system continues to operate to equalize the axle loads as the rig corners or travels up or down grades, or encounters other travel variations. These and other objects, advantages and features of the invention will be more fully understood and appreciated by reference to the drawings and description of the preferred embodiments of the invention.

### BRIEF DESCRIPTION OF THE DRAWINGS

FIG. 1 is a prior art illustration of a load carrying trailer with attached add-on-axle trailer, with the double acting lifter cylinders of the add-on-axle trailer extended;

FIG. 2 is a prior art illustration of a load carrying trailer with attached add-on-axle trailer, with the double acting lifter cylinders of the add-on-axle trailer retracted;

FIG. 3 is a perspective view of a load carrying semi-trailer (a lowboy) with an attached add-on-axle trailer;

FIG. 4 is an enlarged perspective view of the encircled portion IV of FIG. 3;

FIG. 5 is a schematic drawing of the air tank and airbag components of the load carrying trailer and of the add-on-axle trailer;

FIG. 6 is the same perspective view as FIG. 4, but with the load carrying trailer and attached add-on-axle trailer in their cornering position;

FIG. 7 is an enlarged view of encircled area VII of FIG. 6;

FIG. 8A is a schematic drawing of the components of the dynamic load distribution system of the preferred embodiment of the invention;

FIG. 8B is a schematic drawing of the components of the dynamic load distribution system using an electric motor or gas engine operated hydraulic pump of the preferred embodiment of the invention;

FIG. 9A is a portion of a flow diagram for the control system 1 software for the dynamic load distribution system; and

FIG. 9B is the remainder of the flow diagram for the control system 1 software for the dynamic load distribution system.

FIG. 9C is a portion of the flow diagram for the control system 2 software for the dynamic load distribution system;

FIG. 9D is the remainder of the flow diagram for the control system 2 software for the dynamic load distribution system.

FIG. 10A shows the tablet display for the system, and the relationship of the various displays to the computer controlled components and functions on the add-on trailer computer;

FIG. 10B shows the tablet controls and their relationship to the computer controlled components on the add-on trailer and

FIG. 10C shows a variation of the tablet controls.

### DESCRIPTION OF THE PREFERRED EMBODIMENTS

In the following description of the preferred embodiments of the invention, the following numbered parts are referred to:
1 Truck
   1a Truck air compressor which provides 120 psi
   C1 Truck compressed air port which supplies compressed air to the trailer air brake tanks 14 via air-line 18. air conduit also provides air to pass through compressed air to trailer quick disconnect port T2 via air-line 18b.
   C2 Trailer brake compressed air port on truck 1a which provides compressed air to activate the trailer brakes 19 and ultimately to quick disconnect port T3 on the rear of trailer 10, via air-line 18c.
   1b Truck brake pedal
10 Load carrying trailer
   11 trailer frame
   11a goose neck
   12 trailer wheels
   13 trailer axles
   14 trailer air brake tanks
   14a air conduits from air brake tanks 14 to air brakes 19
   15 trailer axle airbags
   16 attachment brackets for attaching the add-on-axle trailer
   17 ride height valve
   18 air conduit from truck port C1
   18a air-lines from air brake tank 14 through ride height valve 17 to airbags 15, and continuing to quick disconnect port T1 at the back of trailer 10
   18b air conduit branching off from line 18 and extending to quick disconnect port T2 at the back of trailer 10.
   18c brake control air-line extending to trailer brakes 19 and to port T3 on the back of trailer 12.
   19 trailer brakes
20 Add-on-axle trailer, or simply add-on-trailer
   21 front attachment frame for attaching to the trailer attachment brackets
   21a pivot mount for receiving add-on-trailer pivot pin
   22 attachment pins
   23 pivot or hinge pin hinging add-on-trailer frame 24 to front attachment frame 21
   23a pivot locking pin (cylinder operated)
   23b locking pin receiving hole
   23c cornering indicator switches
   23d locking pin indicator switch
   24 add-on-axle frame
   24a forward hinge frame
   24b hinge frame pivot axle
   24c hinge frame connecting tongue
   24d hinge frame locking tongue
   25 add-on wheels
   26 add-on axle
   27 add-on-axle trailer air brake tank
   27a add-on-trailer air-line from port T2 to brake air tank 27
   27b add-on-trailer air conduit from port T1 to pressure transducer 44
   27c add-on-axle trailer air-line to control add-on-trailer air brakes 29a
   28 add-on-axle trailer airbags
   28a ride height valve
   28b air-line from brake air tank 27 to air bags 28 via ride height valve 28a
   29 add-on-trailer air brakes
   29a air conduits from air brake tank 27 to air brakes 29
30 Add-on-axle trailer lifter system
   31 double acting hydraulic lifter cylinders
   31a cylinder rods
   31b pin connection of rods 31a to hinge plate 24a
   32 hydraulic pump
   32a check valve
   33 hydraulic cylinder control valve
   34 hydraulic fluid tank (comprises the interior of forward hinge frame 24a)
   34a fluid filter
   35 accumulator shock absorber
   36 shock absorber charging valve
   37 hydraulic pressure sensor transducer
40 Add-on-axle trailer airbag control system
   41 check valve
   43 transducer to monitor add-on-airbag 28 pressure
   44 transducer to monitor trailer airbag 15 pressure
50 Hydraulic pump control system
   51 pressure switch
   52 air tank fill valve
   53 pilot valve for valve 52
   54 hydraulic pump control air tank
   54a air pressure sensor transducer
   55 operating valve for hydraulic pump 32
   56 Pilot valve for valve 55
   57 valve for operating locking pin 23a cylinder
   100-131 are the various functions carried out by the add-on trailer computer system or the operator thereof (the functions are sometimes referred to as steps, or as software modules, and the term module is also used in the claims to refer to software routines which combine the functions of two or more modules as described and shown in the description of the preferred embodiments);
   150 is a representation of a tablet or other PDA, having a display section 160 and a control section 170.

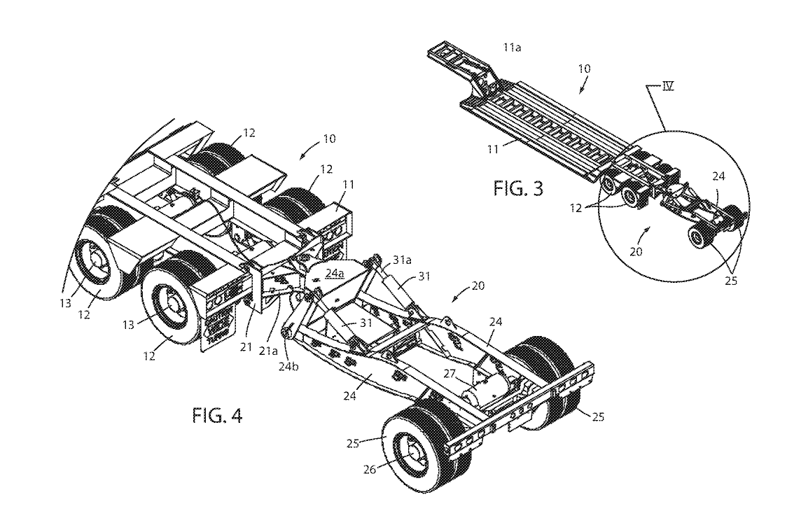

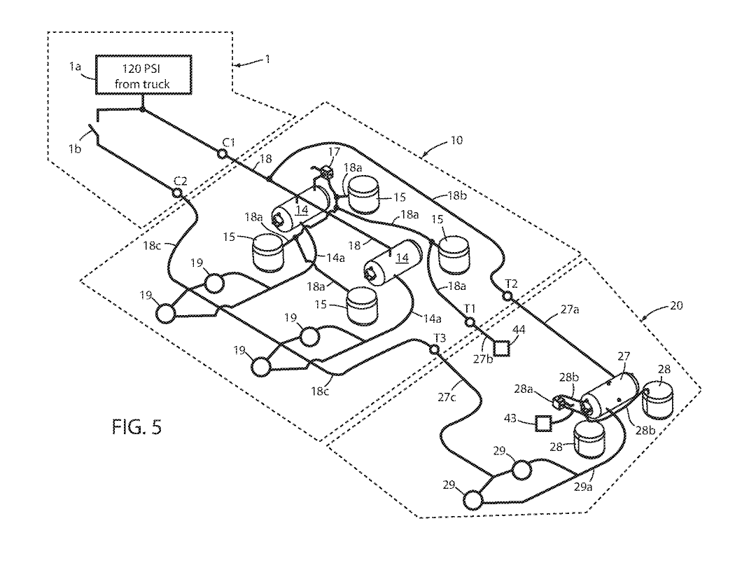

The load carrying trailer 10 used to illustrate the preferred embodiment is a “lowboy” carrier which includes a frame 11 pinned at its goose neck front 11a to a truck and as shown here, includes two rear axles carrying two wheels 12 on each side, for eight wheels total (FIG. 3), though typically a lowboy has three axles and twelve wheels. Air brake tanks 14 are associated with each set of wheels 12 (FIGS. 4, 5). The trailer frame 11 sits on airbags 15 positioned between the trailer axles 13 and frame 11 (FIG. 4). There are two air bags per axle, one near each wheel set. Compressed air from the truck compressor 1a at typically 120 psi is fed to trailer 10 through two ports. C1 and C2 (FIG. 5). Air conduit 18 couples to port C1 via a quick disconnect connector, and feeds compressed air to air brake tanks 14. One of the air brake tanks 14, in this embodiment the lead tank, feeds air to the airbags 15 via conduits 18a. The amount of air in the airbags 15 is controlled by the mechanical ride height valve 17, which allows air to flow through conduits 18a into airbags 15 until the height of trailer 10 is adjusted to its proper ride height. Ride height valve 17 is mechanically linked between frame 11 and an axle 13 so as to continue to maintain proper ride height during travel of the rig. If the trailer frame 11 is too low, the linkage opens the ride height valve 17 to allow air to flow into the air bags 15 to raise the height of frame 11. On the other hand, if frame 11 is riding too high, the linkage opens ride height valve 17 to release air from the airbags 15 and lower frame 1. All the air bags 15 are maintained at a common pressure through their connection via air-line network 18a. One of the conduits 18a connects the network to quick disconnect port T1 at the rear of the trailer.

Air conduit 18b provides pass through compressed air from its junction with line 18 to trailer port T2. (FIG. 5). Air conduit 18c provides brake control air from truck port C2 for activating trailer brakes 19. When truck brake pedal 1b is depressed, brake control air passes through line 18c to control the flow of braking air from air tanks 14 to air brakes 19, via lines 14a. Line 18c connects to trailer port T3, to which the add-on-trailer air brake control line 27c is connected. Thus, the add on trailer air brakes 29 are actuated when the trailer air brakes 19 are activated.

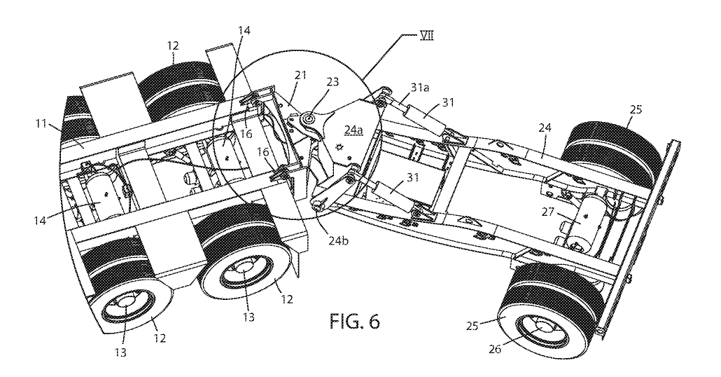

Attachment brackets 16 on the back of frame 11 facilitate the attachment of add-on-axle trailer 20 to load carrying trailer 10 (FIGS. 4, 6 & 7). The trailer compressed air ports T1, T2 and T3 are located on the rear of trailer frame 11.

Add-on-axle trailer 20 comprises a frame 24 with wheels 25 mounted on axles 26, located at the rear thereof (FIG. 3). Frame 24 includes an upstanding front hinge frame 24a, hinged to frame 24 at hinge frame connection or axle 24b (FIGS. 4, 6 & 7). Hinge frame connecting tongue 24c is pivotally connected by pivot pin 23 to the pivot mount portion 21a of front attachment frame 21. Attachment frame 21 is attached to four attachment brackets 16 (two shown) on trailer frame 11 using attachment pins 22.

Air brake tank 27 at wheels 25 is fed by add-on air-line 27a (FIG. 5). Air brake tank 27 also provides air to airbags 28, one of which is located at each side of wheel axle 26, positioned between wheel axle 26 and frame 24. The amount of air fed to airbags 28 is controlled by add-on-axle trailer ride height valve 28a, which positions add-on-axle trailer at the desired normal riding height (FIG. 5), in the same manner as described above for the ride height valve 17 of trailer 10.

Air conduit line 27b on add-on trailer 20 feeds air from trailer port T1 to a pressure monitoring transducer 44 mounted on add-on-trailer 20 (FIG. 5). Transducer 44 measures the pressure in air bags 15 on trailer 10.

Air conduit line 27c connects to trailer port T3, and feeds control air to add-on-trailer brakes 29 (FIG. 5). The braking air is provided to brakes 29 from brake air tank 27 via air brake lines 29a.

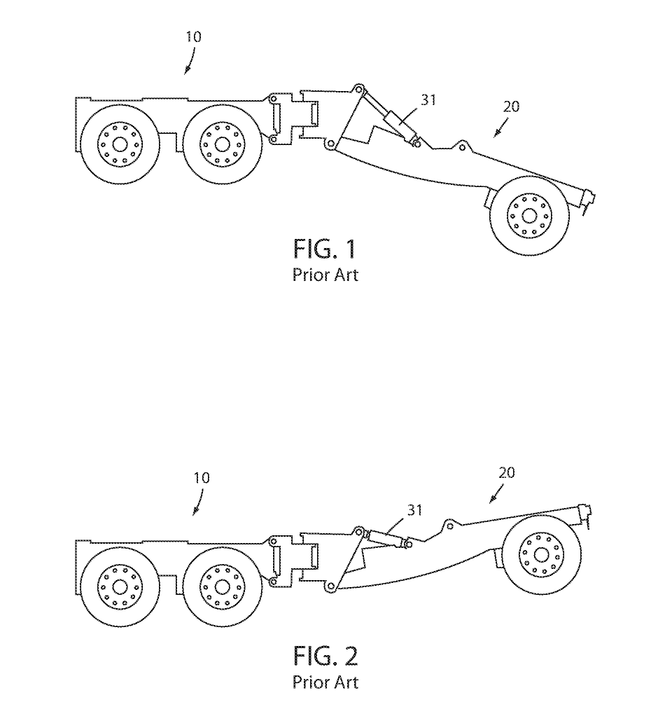

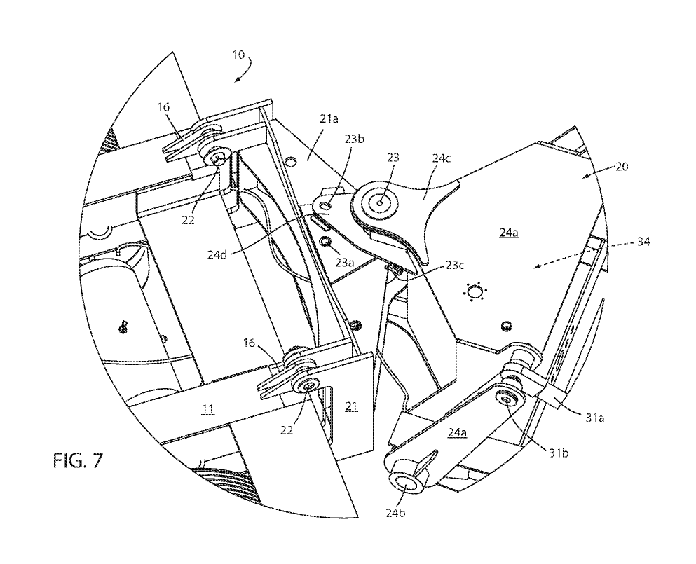

The add-on-axle trailer lifting system 30 includes double acting lifting cylinders 31 pivotally connected at their cylinder end to frame 24, while their cylinder rods 31a are pivotally connected at their ends to the upper portion of hinge frame 24a, via pins 31b (FIGS. 4, 6 & 7). As shown in FIGS. 1 and 2, extension of cylinder rods 31a lifts trailer 10 sufficiently to transfer some of the weight of its load to wheels 25 of add-on-trailer 20. By retracting them, the weight is shifted back to the trailer wheels 12. When the driver wishes to back up, he retracts cylinder rods 31a completely, to thereby lift add-on-axle trailer 20 completely off the ground. To keep it from pivoting from side to side when so lifted, a cylinder operated locking pin 23a is positioned at the top of pivot mounting frame portion 21a, for projection into a hole 23b on a locking tongue 24d. (FIG. 7) Locking tongue 24(d) extends forwardly from hinge frame 24a, below connecting tongue 24c, to thereby lock add-on-axle trailer 20 against pivoting. In normal operation, locking pin 23a is retracted, such that add-on-axle trailer 20 is free to pivot as the rig corners (FIG. 7). A cornering switch 23c is located to each side of the pivoting hinge frame 24a, for indicating that cornering is occurring. In the alternative, a single cornering switch 23c is centrally located on hinge frame 24a, and is triggered to indicate cornering by stationary lugs mounted on either side of the tube on pivot mounting frame 21a in which the pivot pin 23 rotates.

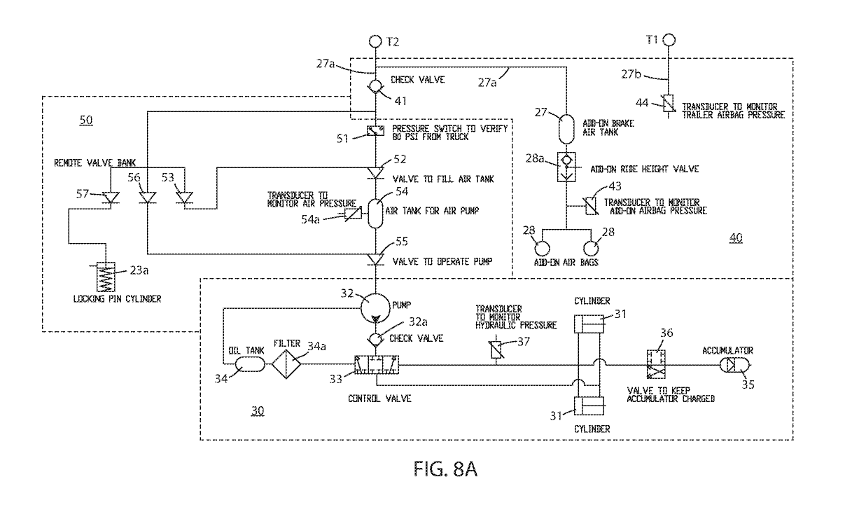

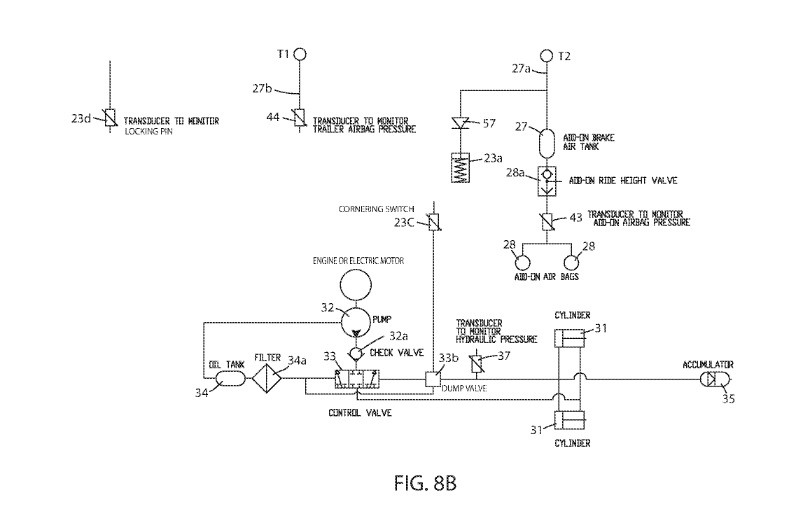

The lifting cylinders 31 are fed hydraulic fluid via hydraulic pump 32 from a hydraulic fluid tank 34, located on the interior of front hinge frame 24a (FIGS. 3, 7, 8A & 8B). Alternatively, fluid tank 34 could be a separate tank mounted on frame 24. The fluid is filtered by filter 34a, and its flow into or out of cylinders is controlled via control valve 33 (FIGS. 8A, 8B). Check valve 32a prevents back-feed into pump 32. The hydraulic fluid pump 32 disclosed in the FIG. 8A preferred embodiment is compressed air driven. However, any type of powered pump can be used, including for example an electric pump or a gasoline powered pump (FIG. 8B). Transducer sensor 37 monitors the hydraulic pressure in the hydraulic system.

Hydraulic fluid is also pumped to an accumulator tank 35, which acts as a shock absorber for add-on-axle trailer 20 (FIGS. 8A, 8B). Tank 35 also includes a head of nitrogen which facilitates its shock absorber action. The control of the flow of fluid to or from tank 35 is via valve 33. A separate optional shock absorber charging valve 36 may be employed as well (FIG. 8A). In operation, valve 36 is open. Valve 36 can be open for purposes of pre-charging accumulator 35, and then closed to hold the pre-charge until the system is ready for use. Alternatively, valve 36 can be closed following normal use of the system in order to hold its charge during non-use.

FIG. 8A illustrates a system including a compressed air valve bank (valves 53, 56 and 57) for controlling the compressed air powered hydraulic pump 32, and for controlling the locking pin 23a. The system illustrated in FIG. 8B uses an electric or gas powered hydraulic fluid pump 32, thus eliminating the need for compressed air valves 53 and 56, check valve 52, pressure switch 51, air tank 54 and transducer 54a, and valve 55. These items are not shown in FIG. 8B.

In operation, cornering and travelling up and down hills, over rough roads and the like will cause imbalanced load problems. The present dynamic load distribution system in its various embodiments automatically maintains a generally uniform load on each of the load carrying trailer axles and the-add-on axle as the rig corners or traverses other travel variations. At the time the trailer is loaded with freight, it also automatically equalizes the per-axle load carried by each axle of the load trailer 10 and the add-on-axle 26.

In the preferred embodiments, three different monitoring and control systems are contemplated. In both control systems 1 and 2, the per axle loads between the load trailer and the add on trailer are automatically equalized by activating the add-on trailer hydraulic system to extend or retract the hydraulic cylinders of the add-on trailer as a function of the air pressure in the load trailer air bags. However, the algorithm for the function differs for the two control systems. Both systems employ a load comparator module which compares the per axle load on the load trailer axles as a function of said load trailer air bag pressure to the load on the add-on trailer axle as a function of either the add-on axle air bag pressure (System 1) or the add-on trailer hydraulic pressure (System 2). When we say the comparator is comparing loads “as a function of,” we are not comparing the respective loads per se. In System 1, we are literally comparing the load trailer air bag pressure to the “area adjusted” add-on axle air bag pressure, each measurement serving as a measure of the load on their respective axles. Thus, the respective loads are compared as a function of the respective air bag pressures. In System 2, the load trailer air bag pressure is converted to “load,” and the add-on trailer hydraulic pressure is converted to load. Thus, the comparator is comparing the load trailer axle load to the add-on trailer axle load, where the loads are determined as a function of the load trailer air bag pressure and the add-on trailer hydraulic pressure.

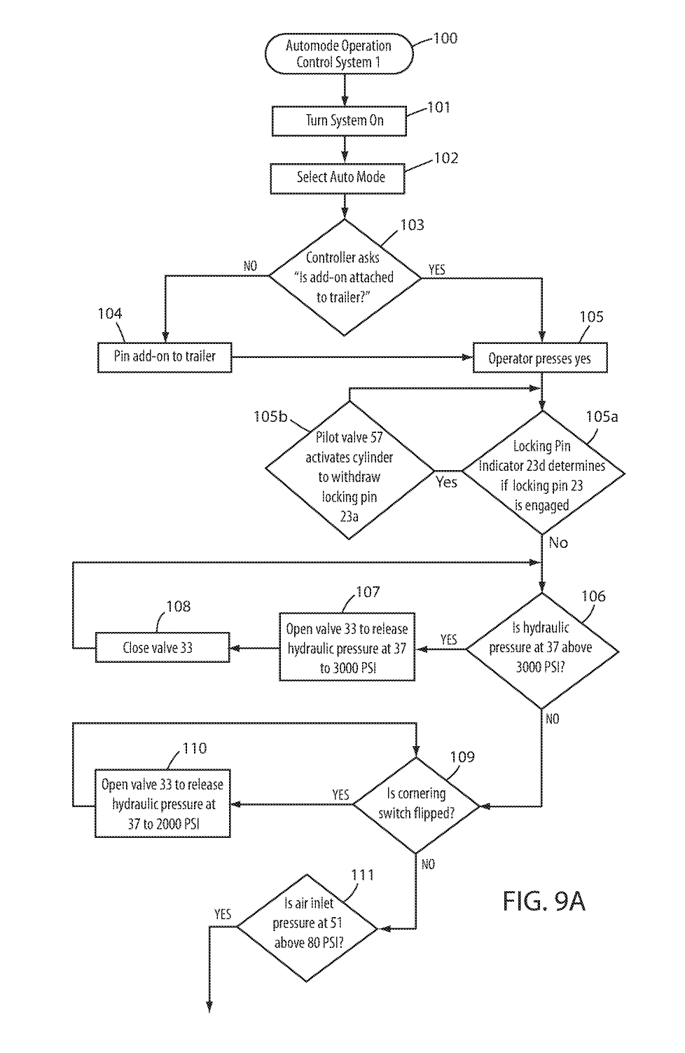

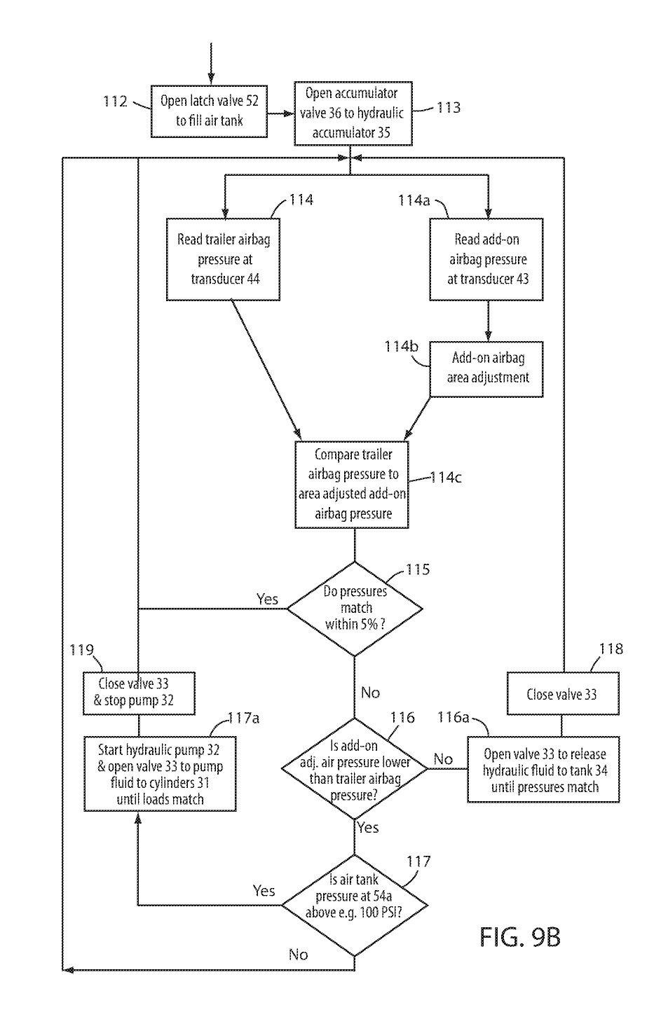

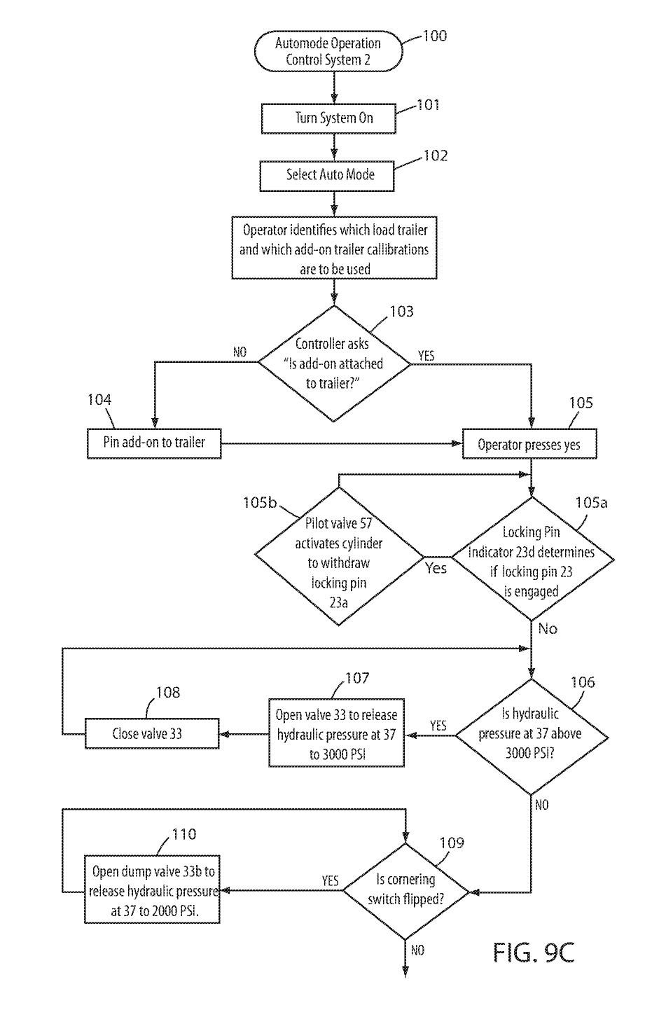

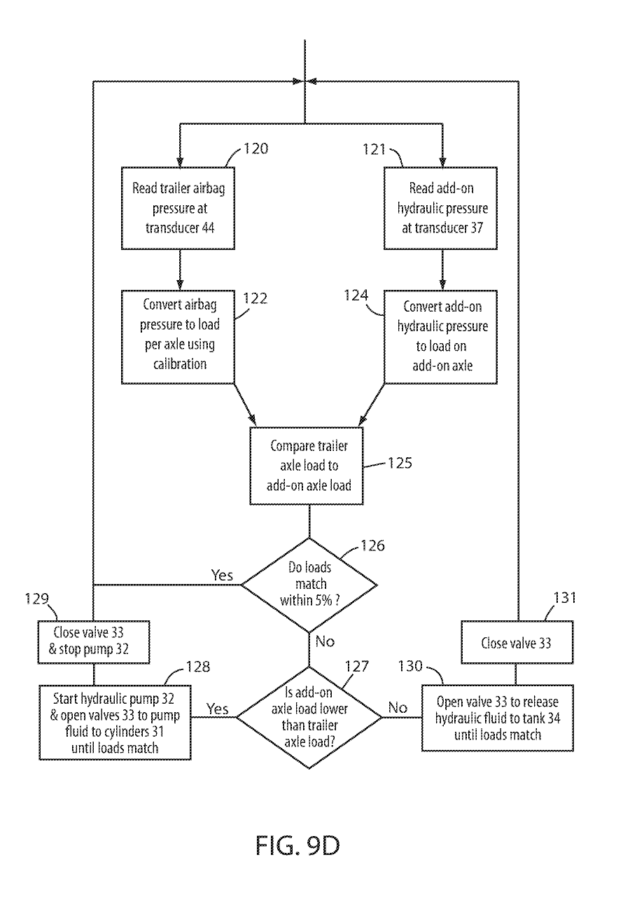

In control system 1 disclosed herein, the system continually monitors the pressure in the load carrying trailer airbag system at transducer 44, and in the add-on-axle trailer airbag system at transducer 43 (FIG. 8A or 8B). The system automatically adjusts the hydraulic pressure in the add-on-axle trailer hydraulic system, such that the “area adjusted” pressure in the add-on-axle trailer air bags (explained below) matches the average pressure in the load carrying-trailer air bag system. (FIGS. 9A, 9B) In this way, the load is equalized between all the trailer 10 axles and the add-on-trailer axle 26. This occurs automatically both when the trailer is initially loaded with freight, and as it travels to its destination.

In control system 2, the system continually monitors the load trailer air bag pressure at transducer 44, and the hydraulic pressure at transducer 37 (FIG. 8A or 8B). Converter modules 122 and 124 convert the pressure indications to the loads associated with said indications. The system than equalizes the load on the load trailer axles and add-on-trailer axle by adjusting the hydraulic pressure in the add-on-trailer cylinders 31 until the loads match. The system monitors the pressure in the load carrying trailer airbag system at transducer 44, and adjusts the hydraulic pressure in the add-on-axle trailer cylinders 31, to automatically initially and continually maintain the load on the add-on-trailer axle the same (within a predetermined percentage) as the load on each axle of the load carrying trailer. A third option is a combination of the first and second options, operating in accordance with a control algorithm which blends and utilizes the information ascertained from both to achieve the desired result.

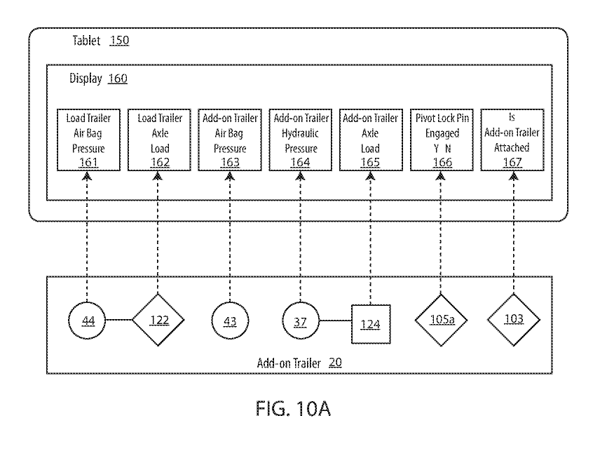

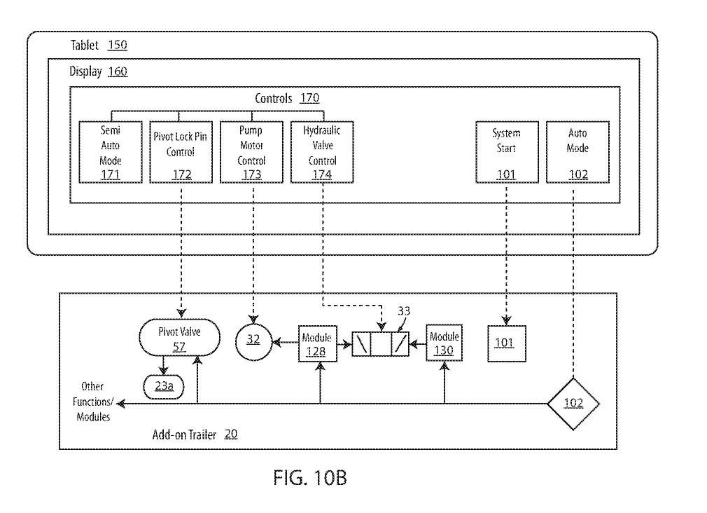

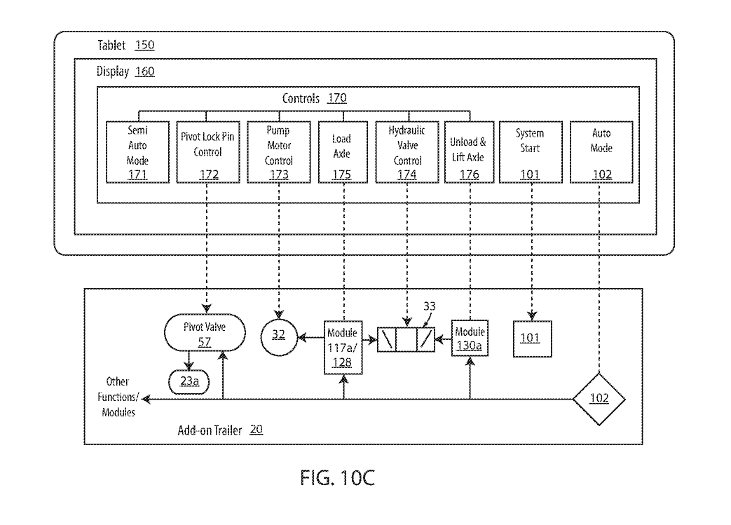

Each mode of operation includes an automatic mode, requiring minimal operation by a human operator, and a semi-automatic mode which facilitates more hands-on control. Automatic operation and semi-automatic operation can be initiated and controlled at a control panel on the add-on trailer, but is preferably initiated and controlled from the software loaded tablet or PDA 150, which includes a wireless connection (represented by dashed lines) to the add-on trailer computer system (FIGS. 10A, 10B). The operator begins by powering up the system at 101, either at the add-on trailer control panel or on tablet 150. The operator then selects auto mode 102, which activates the add-on trailer mounted computer system, or the semi-automatic mode, which facilitates control of certain functions directly and remotely. (FIGS. 10B, 10C).

In the first option embodiment, initial set up and continual ride adjustment is achieved by monitoring and continually adjusting as required the air pressure in the load carrying trailer airbags as compared to pressure in the add-on-axle trailer airbags, using the add-on-axle trailer airbag control system 40 (FIGS. 5, 8A). Compressed air at 120 psi enters system 40 is fed via quick disconnect conduit 27a, to the air brake tank 27. Compressed air from tank 27 is fed to airbags 28 via ride height valve 28a. Valve 28a is opened either to air conduit 27a or to atmosphere to feed air into or bleed air from air bags 28 to maintain add-on-axle trailer 20 at the correct predetermined height. Pressure in airbags 28 is monitored by transducer 43. Pressure in airbags 15 on trailer 10 is monitored by transducer 44 on conduit 27b, which is connected to trailer port T1.

Because in this embodiment, hydraulic pump 32 is air driven by truck compressed air, rather than being electrical or gasoline powered, a hydraulic pump air control system 50 is required (FIG. 8A). Truck compressed air entering via quick disconnect air conduit 27a passes through check valve 41 to pressure switch 51, which opens at 80 psi or above, as a safety measure to ensure that air brake pressure in the rest of the compressed air system does not fall below the pressure required to operate the trailer and add-on-axle trailer air brakes. Air tank fill valve 52 is opened via a pilot valve 53 to fill hydraulic pump air tank 54. A transducer 54a on air tank 54 monitors the air pressure in tank 54, for the purpose of insuring that it does not fall so low that its outflow to operate hydraulic pump 32 would possibly jeopardize the air pressure in the system to the point that the air brakes would not operate. In this embodiment, a valve 55 between tank 54 and hydraulic pump 32 will not open if the pressure in tank 54 is below a pre-determined pressure, e.g. 100 psi. Valve 55 is activated by pilot valve 56. Another pilot valve 57 is used to activate or deactivate lock pin 23a, for locking add-on-axle trailer 20 against pivoting.

The preferred embodiment computer control system 1 for operation of the dynamic load distribution system is illustrated in the flow diagram of FIGS. 9A and 9B. Instructions indicated are done automatically by the computer software (or hardware) unless otherwise indicated. The system is activated to automatic mode at step 101, where the operator turns the system on, and at 102 where the operator activates the system to “auto-mode.” These steps can be performed remotely on the tablet 150, or at the add-on trailer control panel. At 103, the controller asks if the add-on-axle trailer 20 has been attached to the load carrying trailer 10. If not, the operator must manually complete the attachment operation by inserting attachment pins 22 through the openings provided in attachment bracket 21 and trailer frame 11 mounted attachment brackets 16. Once completed, the operator presses a “yes” button at step 105.

Module 105A determines via locking pin indicator 23d whether locking pin 23a is engaged in aperture 23b in locking tongue 24d. If it is engaged, module 105b instructs pilot valve 57a to activate the cylinder of locking pin 23a, to withdraw it from aperture 23b in locking tongue 24d. This allows add-on-trailer to pivot from side to side as the rig corners.

Control system 1 then asks at module 106, via hydraulic pressure transducer 37, whether the hydraulic pressure in the system is above a predetermined value. If it is, module 107 opens valve 33 to tank 34 to release the hydraulic pressure to a lower level. Valve 33 is then closed at 108.

Preferred embodiment control system 1 includes an optional cornering feature at steps 109 and 110. Software module 109 asks whether a cornering indicator switch 23c indicates that the rig is cornering. If it is, valve 33 is opened to tank 34 to release the hydraulic pressure level to a lower level, e.g. 2000 psi, as indicated by transducer 37. This keeps add-on-axle trailer 20 from lifting trailer 10 to an unsafe height as the rig corners. This is an optional additional feature, in that even without this feature, the rest of the monitoring system and adjustment method should automatically accomplish this result, as will be discussed below. However, it does provide a more direct control of cornering control.

Module 111 then asks whether the air pressure at pressure switch 51 is above a level sufficient to ensure that the air brakes will have sufficient pressure to operate, for example above 80 psi. If so, pilot valve 53 is instructed to open valve 52 by module 112, and air flows to air tank 54. Various approaches can be used to ensure that the flow of air to tank 54 does not bleed off too much pressure from the rest of the system. Thus, if the pressure falls below 80 psi during the process, valve 52 can be closed until the pressure rises again. Alternatively, valve 52 can be opened only at short intervals, with a delay there between to give the system time to recover from any drop-in pressure.

Step/module 113 also proceeds if the pressure at pressure switch 51 is above 80 psi, thus opening the electrically powered hydraulic accumulator valve 36. This allows hydraulic fluid to flow into the shock absorbing accumulator tank 35.

At module 114, the software is continually reading the load trailer airbag pressure as indicated by transducer 44. The pressure is averaged over an interval, such as 30 seconds. Alternatively, trending software is used, as opposed to averaging software. Since the load trailer air bags are identical, the pressure reading at transducer 44 is representative of the per axle load on each load trailer axle. If the add-on trailer air bags were the same configuration as the load trailer air bags, one could insure equal per axle distribution of the load simply by making the airbag pressure of the load trailer airbags equal to the add-on axle air bag pressure. However, the add-on trailer air bags are typically smaller, having a smaller area than the load trailer air bags. Thus, to provide equal load distribution by equating load trailer air bag pressure to add-on axle air bag pressure, the add-on airbag pressure reading must be “area adjusted.”

Module 114a reads the average add-on-axle trailer airbag pressure as indicated by transducer 43, and averages or trends it as is done above for the load trailer airbag pressure. Software module 114C then makes an area adjustment so that the area adjusted air pressure readings for the add-on trailer air bags are the same as they would be if the add-on trailer air bags had the same configuration as the load trailer air bags. The airbag working area for different load carrying trailers will vary from trailer to trailer, and the airbags used on the add-on-axle trailer will typically be smaller in working area than those on the load carrying trailer. Thus, in determining whether the load trailer airbags with a psi of X and the smaller add-on airbags with a psi of Y are carrying the same load, area adjustment module 114C must divide the working area of the per axle load trailer airbags by the working area of the per axle add-on-axle trailer airbags to determine a ratio Z, and then compare Y/Z to X and determine whether those numbers are comparable. By “comparable,” we mean the values are equal or are within some variation from equal which those operating the system would regard as reasonable. We have used a variation of 5% for purposes of exemplification herein, but recognize that greater or lesser variations would be acceptable to experienced rig operators. The Y/Z value is referred to as the “area adjusted pressure” for the add-on-axle trailer airbags.

For example, in a system having a trailer air bag with an upper working circular surface which is 2 ft. in diameter over each wheel, and an add-on airbag which has a working surface which is 1 ft. in diameter over each wheel, the working area of each trailer air bag would be 4 times the working area of each add-on-axle trailer airbag (3.14/0.785=4). Assuming a pressure of 60 psi on the trailer airbags, the “area adjusted pressure in each of the add-on airbags would have to be 240 psi to lift the same load. Thus, the system would compare 60 psi to 240 psi/4, and conclude that at 60 psi and 240 psi, respectively, the trailer axles and the add-on-axle axles are carrying the same load.

Module 115 asks whether the load trailer air bag pressure matches the “area adjusted add-on trailer air bag pressure, preferably within a predetermined acceptable limit, for example 5%. If they do, the system monitors the pressures again for the predetermined time interval, to determine whether they still match to within the limit. If the pressures do not match within 5%, module 116 asks whether the add-on airbag pressure is lower than the trailer airbag pressure. If it is not, module 116a opens hydraulic control valve 33 to tank to drain fluid back into tank 34 and thereby reduce the pressure in cylinders 31, until the area adjusted pressure equals the load carrying trailer pressure at transducer 44. Module 118 then closes valve 33. If the add-on airbag area adjusted pressure is lower than the trailer airbag pressure, module 117a starts hydraulic pump 32 and opens valve 33 to cylinders 31, to extend cylinder rods 31a and thereby increase pressure on add-on airbags 28, and reduce the pressure on trailer airbags 15. When they are equalized or reach a targeted value, Module 119 then closes valve 33 and turns off pump 32. Because pump 32 is air driven, there is another step in the process at module 117. Module 117 asks whether the pressure at air tank transducer 54a is above a predetermined pressure, e.g. 100 psi. If it is not, the system recycles until the 120-psi source from the truck is able to build it up to at least the predetermined level. This is a safety measure, to make sure the operation of the air driven pump 32 does not bleed off so much air pressure that the air brakes will not work. If pump 32 were electric or gasoline powered, module 117 would not be necessary.

The control system 1 operates automatically to equalize the per axle load between the trailer and the add-on trailer when trailer 10 is first loaded, and during the continuing travel of the rig from start to finish.

In the second option, control system 2, each trailer or type of trailer is calibrated to determine load per axle which the trailer will be carrying at a given air bag pressure. This calibration is performed once for each trailer, and the information stored in the control software. To accomplish the calibration, the weight of the load carrying trailer empty is measured, and the air pressure on the trailer axles is noted. A load is then added to the load carrying trailer, its weight determined, and the air bag pressures on its axles noted. We have found that the relationship between trailer load and air bag pressure is linear, such that the correlation between air bag pressure and load for each axle can be determined from these two preliminary measurements, and of course the number of axles for the trailer.

The relationship between the hydraulic pressure in the add-on-trailer and the load on the add-on-trailer axle is also calibrated (usually provided by the manufacturer) and stored in the computer control software.

The computer software (hardware) control system employing option 2 is illustrated in FIGS. 9C and 9D. In addition, the control system of FIGS. 9C and 9D utilizes an electric or gas-powered motor for hydraulic fluid pump 32, as shown in FIG. 8B. The operations set forth in FIG. 9C are the same as for FIG. 9A, except that: (1) the operator inputs into the computer system the particular load carrying trailer and the particular add-on-trailer being used, such that the appropriate stored load calibrations will be used by the software, (2) operation 111 of FIG. 9A is eliminated, since it relates to a compressed air operated hydraulic pump 32, and the system of 9C and 9D uses an electric or gas powered motor to operate hydraulic pump 32; and (3) the cornering option is modified in that if the cornering switch is activated at module 109, module 110 opens a dump valve 33b, rather than the cylinder drain position of valve 33, which more rapidly dumps hydraulic fluid directly into tank 114 (FIG. 8B) to reduce pressure in cylinders 31 more rapidly. The compressed air powered pump 32 could be used in control option 2, but it is not in this embodiment as disclosed.

Software module 120 reads the load trailer airbag pressure via transducer 44. Converter module 122 converts this pressure reading to the load per trailer axle, using the “pressure to load” calibration for the load carrying trailer being used. In module 121, the add-on-trailer hydraulic pressure is determined from transducer 37. At converter module 124, the hydraulic pressure is converted to the load on the add-on axle. This conversion information is typically provided by the manufacturer, but can be calibrated by the operator.

In module 125, the average per axle trailer load is compared to the average add-on axle load over a predetermined interval of time (e.g. 15-30 seconds). If they are comparable, e.g. within a predetermined percentage of one another, e.g. 5% (determination by module 126), the system recycles through these operations until a divergence greater than 5% occurs. If so, interrogator module 127 inquires whether the add-on axle load is lower than the load trailer axle load. If it is, software module 128 automatically starts hydraulic pump 32 and opens valve 33 to pump fluid to cylinders 31, until the loads match. Module 129 then closes valve 33 and turns off pump 32. If the load on the add-on axle is not lower than the load per trailer axle, it is of course higher, and module 130 automatically opens valve 33 to release hydraulic fluid to tank 34, until the loads match. Module 131 then closes valve 33

As above, the control system 2 operates automatically to equalize the per axle load between the trailer and the add-on trailer when trailer 10 is first loaded, and during the continuing travel of the rig from start to finish. An option 3 system dynamically monitoring both air bag pressures and cylinder pressures would have to blend both algorithms.

The operator can monitor system operation remotely on his or her tablet computer 150. The display section 160 on the computer screen may include:
A load trailer air bag pressure display 161, which receives wirelessly the read out of load trailer air bag pressure transducer 44 (FIGS. 10A, 8A and 8B;
The “per axel” load trailer axel load display 162, which displays the computer calculated axel load from computer operation 122 (FIGS. 10A, and 9D);
The add-on trailer air bag pressure display 163, reading transducer 43 (FIGS. 10A and 8B);
The add-on trailer hydraulic pressure display 164, reading the output of transducer 37 (FIGS. 10A and 8B);
The add-on axle load 165 from computer module 124 (FIGS. 10A and 9D);
The add-on trailer pivot lock pin indicator 166 reading indicator module 105a (FIGS. 10A and 9C);
The add-on trailer “attached” indicator 167, which reads the computer module 103.

The “controls 170, which are preferably touch screen activated from the display 160 of tablet 150, may include (as shown in FIG. 10B):
A system start switch which powers up the computer system on add-on axle trailer 20 (such a switch is also provided at the add-on axle trailer control panel);
A semi-auto mode switch 171, which allows control of various functions of the software system from tablet 150;
An auto mode switch 102 (also located at the add-on axle control panel) which activates the automatic mode for the software;
Pivot lock pin control 172, which controls pivot valve 57 for controlling the position of pivot lock pin 23a;
Pump motor control 173, for turning pump 32 on or off; and
Hydraulic valve control 174, for controlling the position of hydraulic fluid flow valve 33.

The controls and display software for tablet 150 can of course be varied. In a preferred simplification, a “load axle” control 175 could be added which would control both pump 32 and valve 33 by activating software module 117a (option 1 system) or module 128 (option 2 system) (FIGS. 9B, 9D, & 10C). This would transfer weight from the load trailer axles to the add-on axle. An “unload & lift axle” control 176 would activate module 130a to turn on pump 32 and position valve 33 to put back pressure on add-on trailer hydraulic cylinders. (FIG. 10C), and lift add-on trailer 20 off the ground (FIG. 2). (The unload axle module 130 positions valve 33 to allow fluid to drain from cylinders 31 back to tank 34. Module 130a is an “unload and lift module,” which not only positions valve 33 to the drain position, but also activates pump 32 to pump fluid into the contracting side of cylinders 31, causing them to contract and lift add-on trailer 20 off the ground.)

There are certain functions which can be performed semi-automatically, and one which must be. To perform functions semi-automatically, the user turns on the semi auto mode 171, on tablet 150, or at the add-on trailer control panel (FIG. 10B or 10C). Semi-automatic operation is necessary when the operator must reverse the rig. He must activate pivot valve 57 to cause pivot lock pin 23a to move toward engagement, and then pull the rig forward until the add-on trailer straightens out sufficiently for pin 23a to engage aperture 23b in on a locking tongue 24d (FIG. 7). (Although lock pin 23a is visible in FIG. 7, it would be located beneath tongue 24d, such that when lock pin engagement is activated, it presses upwardly against the bottom of tongue 24d until it snaps into receiving locking aperture 23b. With the pin thus locked, the operator activates pump motor control 173, and then position hydraulic fluid valve 33, to lift add-on trailer 20 off the ground (see FIG. 2). Alternatively, with the control functions shown in FIG. 10C, the operator can touch the unload axle control 176 which controls software module 130a, which controls pump 32 and the position of valve 33 to lift add-on axle trailer off the ground. The operator can then back the rig up without having jack knife issues with add-on trailer 20.

One optional semi-automatic operation would be the initial load distribution between the load trailer axles and the add-on trailer axle. When the trailer is loaded, the operator can monitor the per axle load on the load trailer axel load display 162 remotely on his or her tablet or PDA 150, or at the add-on axle trailer display. When the loading is completed, the operator can activate the hydraulic fluid pump 32 at pump control 173, and the hydraulic fluid valve using valve control 174 (FIG. 10B). In the control system shown in FIG. 10C, the operator can simply touch load axle control 175, and software module 128 will control the start of pump 32 and the proper positioning of valve 33. The “semi-automatic” mode can be programmed in two different or alternative ways. By incorporating the comparator modules/routines shown in FIG. 9B or 9D, the activation of load axle control 175 will automatically allow hydraulic fluid to flow until the load on the axles automatically equalizes. Alternatively, the operation can be less automated, requiring the operator to close valve 33 at control 174 when his or her displays indicate that the per axle loads match. An experienced operator would be able to equalize the loads without the benefit of per axle load displays 162 and 165, based on reading the load trailer air bag pressure at 161 and the add-on trailer hydraulic pressure at 164.

Other features can be programmed into the system. For example, tablet 150 can be provided with a backup camera display.

Of course, it is understood that the forgoing are preferred embodiments of the invention, and that various changes and alterations could be made without departing from the spirit and broader aspects of the invention, as set forth in the appended claims.

1. A load distribution system for equalizing the per axle load between a load carrying trailer and an add-on axle trailer in which load is transferred from the load carrying axles to the add-on axel by pumping fluid into and extending at least one hydraulic cylinder of the add-on trailer, and in which load is transferred from said add-on axle to said load trailer axles by draining hydraulic fluid from said at least one hydraulic cylinder, said system comprising:
a load trailer air bag pressure monitor module for monitoring the load trailer air bag pressure;
an add-on axle trailer monitor for monitoring one of (1) the add-on axle air bag pressure and (2) the add-on trailer hydraulic pressure;
a load comparator module which compares the per axle load on the load trailer axles as a function of said load trailer air bag pressure to the load on the add-on trailer axle as a function of one of the add-on axle air bag pressure or the add-on trailer hydraulic pressure;
a load axle hydraulic flow activation module which responds to an indication that the load on the add-on axle is lower than the load on each load trailer axle by activating said pump and positioning said hydraulic fluid flow valve to pump hydraulic fluid into said at least one hydraulic cylinder to extend it until said comparator module indicates that the per axle load on said load trailer axles and on said add-on axle are comparable; and
an unload axle hydraulic flow activation module which responds to an indication that the load on the add-on axle is higher than the per axle load on said load trailer axles by positioning said hydraulic fluid flow valve to drain hydraulic fluid out of said at least one hydraulic cylinder to allow it to retract until said comparator module indicates that the per axle load on said load trailer axles and on said add-on axle are comparable.

2. The load distribution system of claim 1 which further comprises:
a load trailer air bag pressure converter module which converts the load trailer air bag pressure indication to an indication of the load on each axle of the load trailer;
said add-on axle trailer monitor comprising a hydraulic pressure monitor for monitoring the hydraulic pressure in the add-on trailer;
a hydraulic pressure converter module for converting the add-on trailer hydraulic pressure indication to an indication of the load on the add-on trailer axle;
said load comparator module comprising a comparator module which compares the per axle load on the load trailer axles, as determined by said a load trailer air bag pressure converter module, to the load on the add-on trailer axle, as determined by said hydraulic pressure converter module.

3. The load distribution system of claim 2 which also includes:
a comparator module interrogator which asks said comparator module if the add-on trailer axle load and the load trailer axle load are comparable; and
a second interrogator which responds to an indication by said comparator interrogator module that said add-on axle load and said load trailer per axle load are not similar by asking whether the add on axle load is one of lower or higher, and then activates said load axle module or said unload axle module as appropriate for the answer given.

4. The load distribution system of claim 3 which also comprises:
said system comprising control software carried on said add-on axle trailer; and
a display and control module for loading into a portable computer with wireless connection to said control software on said add-on trailer, such that said load distribution system can be operated remotely.

5. The load distribution system of claim 4 which also comprises:
said display and control module including a display showing the per axle load on said load trailer axles;
a display showing the load on said add-on axle;
a load axle control for activating said load axle module; and
an unload axle control for activating said unload axle module, whereby said load distribution system can also be operated in a semi-automatic mode.

6. The load distribution system of claim 1 which also comprises:
a cornering switch for indicating when said add-on axle trailer is cornering; and
a cornering control module for positioning said hydraulic fluid flow valve to drain hydraulic fluid out of said at least one hydraulic cylinder until said hydraulic pressure is reduced to a predetermined level deemed safe for cornering, and then closes said valve.

7. The load distribution system of claim 1 which also comprises:
said an add-on axle trailer monitor comprising an add-on trailer air bag pressure monitor;
an add-on air bag area adjustment module which makes an area adjustment so that the area adjusted air pressure readings for the add-on trailer air bags are the same as they would be if the add-on trailer air bags had the same configuration as the load trailer air bags;
said load comparator module comprising a comparator module which compares the load trailer air bag pressure to the area adjusted add-on axle air bag pressure;
said load axle hydraulic system flow activation module and said unload axle hydraulic system flow activation module responding to the relative differences between said load trailer air bag pressure and said area adjusted add-on air bag pressure, as determined by said comparator module.

8. The load distribution system of claim 7 which also includes:
a comparator module interrogator which asks said comparator module if the add-on trailer axle area adjusted air bag pressure and the load trailer axle air bag pressure are comparable; and
a second interrogator which responds to an indication by said comparator interrogator module that said add-on axle and said load trailer per axle air bag pressures are not comparable by asking whether the add on axle load is one of lower or higher, and then activates said load axle module or said unload axle module as appropriate for the answer given.

9. The load distribution system of claim 8 which also comprises:
said system comprising control software carried on said add-on axle trailer; and
a display and control module for loading into a portable computer with wireless connection to said control software on said add-on trailer, such that said load distribution system can be operated remotely.

10. The load distribution system of claim 9 which also comprises:
said system control software including an unload and lift axle module which operates said pump and said fluid flow valve control to pump hydraulic fluid into said at least one hydraulic cylinder to retract it, until said add-on axle trailer is unloaded and lifted off the ground;
said display and control module including:
a display showing the per axle load on said load trailer axles;
a display showing the load on said add-on axle;
a load axle control for activating said load axle module; and
an unload and lift axle control for activating said unload and lift axle module, whereby said load distribution system can also be operated in a semi-automatic mode.

11. A load distribution system for equalizing the per axle load between a load carrying trailer and an add-on axle trailer in which load is transferred from the load carrying axles to the add-on axel by operating a hydraulic fluid pump and a fluid flow control valve to pump fluid into and extending at least one hydraulic cylinder of the add-on trailer, and in which said add-on axle trailer can be unloaded and lifted by operating said pump and said fluid flow control valve to pump hydraulic fluid into said at least one hydraulic cylinder to cause it to retract, said system comprising:
system control software carried on said add-on axle trailer, which includes:
a load trailer air bag pressure monitor module for monitoring the load trailer air bag pressure;
an add-on axle trailer module for monitoring one of (1) the add-on axle air bag pressure and (2) the add-on trailer hydraulic pressure;
a pump control module for turning on said hydraulic fluid pump; and
a valve control module for positioning said fluid flow control module;
a display and control module for loading into a portable computer with wireless connection to said control software on said add-on trailer, such that said load distribution system can be operated remotely, said display and control module including:
a display showing said load trailer air bag pressure;
a display showing one of said add-on trailer air bag pressure or said add-on trailer hydraulic pressure;
a pump control activating said pump to pump hydraulic fluid to said at least one cylinder; and
a fluid flow valve control for positioning said fluid flow control valve to either extend said cylinder and thereby transfer load from load trailer axles to said add-on axle, or to retract and transfer load from said add-on axle and lift said add-on axle trailer off the ground.

12. The load distribution system of claim 11 which also comprises:
said system control software including:
a load comparator module which compares the per axle load on the load trailer axles as a function of said load trailer air bag pressure to the load on the add-on trailer axle as a function of one of the add-on axle air bag pressure or the add-on trailer hydraulic pressure;
a load axle module which operates said pump and said fluid flow valve control to pump hydraulic fluid into said at least one hydraulic cylinder to extend it, until said comparator module indicates that the per axle load on said load trailer axles and on said add-on axle are comparable; and
said display and control software including a “load axle” control which activates said load axle module, to automatically load the add-on axle until the per axle load on the load trailer axles and on the add-on trailer axles are comparable.

13. The load distribution system of claim 12 which also comprises:
said system control software including an unload and lift axle module which operates said pump and said fluid flow valve control to pump hydraulic fluid into said at least one hydraulic cylinder to retract it, until said add-on axle trailer is unloaded and lifted off the ground; and
said display and control software including an “unload and lift axle” control which activates said unload and lift axle module, to automatically unload and lift the add-on axle trailer off the ground.

14. The load distribution system of claim 11, in which:
said display and control module includes a load trailer per axle display and an add-on axle load display.

15. The load distribution system of claim 13 in which:
said system control software includes a pivot lock pin module for monitoring and controlling the position of a pivot locking pin which can be activated to lock said add-on trailer against pivoting; and
said display and control software including a pivot lock pin position display, and a pivot lock pin control for locking or unlocking said pivot pin by controlling said pivot lock pin control module.

16. The load distribution system of claim 11 in which:
said system control software includes a pivot lock pin module for monitoring and controlling the position of a pivot locking pin which can be activated to lock said add-on trailer against pivoting; and
said display and control software including a pivot lock pin position display, and a pivot lock pin control for locking or unlocking said pivot pin by controlling said pivot lock pin control module.

17. The load distribution system of claim 1 which comprises:
said hydraulic pump being an air pressure operated hydraulic pump;
an air tank for providing air to power said pump;
a connector for connecting said air tank to the air compressor system of a truck;
a first air conduit connecting said connector to said tank;
a second air conduit connecting said air tank to said air pressure operated hydraulic pump;
an air pressure pump operating valve on said second air conduit, between said air tank and said pump;
a first pilot valve for opening said pump operating valve;
a third air conduit connected to said first air conduit at a point between said connector and said air tank, and extending to said first pilot valve, and a fourth air conduit extending from said first pilot valve to said pump operating valve:
a pump control software module for turning said hydraulic pump on by opening said first pilot valve, which allows pressurized air to flow through said fourth conduit to said pump operating valve, thus opening it, and allow air under pressure to flow from said air tank to said air powered hydraulic pump.

18. The load distribution system of claim 17 which comprises:
an air pressure operated tank fill valve positioned on said first air line between said connector and said air tank;
a second pilot valve for controlling said tank fill valve;
said third air conduit also extending to said second pilot valve;
a fifth air conduit extending from said second pilot valve to said tank fill valve; and
an air tank fill software module for filling said air tank with air under pressure by opening said second pilot valve, which allows pressurized air to flow through said fifth conduit to said tank fill valve, thus opening it, and allowing air under pressure to flow from said connector into said air tank.

19. The load distribution system of claim 18 which includes:
an air inlet pressure switch positioned on said first conduit between said connection of said third air conduit to said first conduit, and said tank fill valve, for assuring that the air inlet pressure into said first air conduit is at a predetermined operating pressure; and
a software module for reading said air inlet pressure switch and preventing opening of said tank fill valve unless said predetermined operating pressure has been reached.
